(19) United States
(12) Patent Application Publication
(10) Pub. No.: US 2008/0096071 A1
(43) Pub. Date: Apr. 24, 2008

(54) Line System for a Supplying and/or Discharging Fluids for a Fuel Cell

(75) Inventors: Fahri Keretli, Le Mesnil Saint Denis (FR); Marielle Marchand, Saclay (FR); Anna-Maria Morgante, Le Plessis Robinson (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT s.a.s., Boulogne Billancourt (FR)

(21) Appl. No.: 11/576,818

(22) PCT Filed: Oct. 7, 2005
(86) PCT No.: PCT/FR05/50833

§ 371 Date: Dec. 27, 2007

(30) Foreign Application Priority Data
Oct. 11, 2004 (FR) 0410702

(51) Int. Cl. H01M 8/02

(52) U.S. Cl. 429/26; 429/34

(57) ABSTRACT

The invention relates to a line system for supplying and/or discharging fluids for an assembly of at least two identical fuel cell modules (A, B, C, D), in particular mounted on a motor vehicle, each of which comprises an elementary cell (21) stack and input and output pipes (1, 2, 3, 4, 5,) for different fluids required for operation of the fuel cell, wherein said pipes are arranged on at least one external surface of each module and the supply and/or discharge lines for at least one fluid are connected to the corresponding pipes of the module assembly by means of a single main line (C₁) or several successive secondary branches (C₂, C₃) of the symmetric structure of each module, respectively.

The present invention relates to a line set for supplying and/or discharging the fluids needed for the operation of a collection of fuel cell modules, it being possible in particular for such a collection to be mounted in a motor vehicle.

A fuel cell is capable of producing electricity from hydrogen or from a hydrogen-rich gas and from oxygen or an oxygen-rich gas, such as air. The hydrogen needed for the reaction in the fuel cell may be stored onboard a motor vehicle or produced in the motor vehicle itself, by means of a reforming device supplied with hydrogen-containing fuel, such as gasoline, diesel oil ethanol, etc. This hydrogen or this hydrogen-rich gas thus produced is brought by a supply line to the anode-side inlet of the fuel cell. In the same way, air, generally compressed air, is brought by a supply line to the cathode-side inlet of the fuel cell. In addition, it may be necessary to make the fuel cell operate at a set temperature, which means that a heat-transfer fluid also has to be circulated within the fuel cell in order to keep the operating temperature at a suitable level.

A fuel cell used for motor vehicle traction generally comprises a number of identical modules, each module comprising a stack of elemental individual cells. The power needed for motor vehicle traction is actually several tens of kilowatts, which entails stacking a great many elemental a individual cells in order to obtain the desired power. For mechanical stacking reasons and to ensure appropriate operation it is, however, preferable to limit the size of each module to a stack of around one hundred individual cells at most.

Various set-ups for arranging several modules, the electrical output of which is generally connected in series, have already been envisioned. Thus, U.S. Pat. No. 5,480,738 describes a fuel cell module arrangement in the form of two columns mounted side by side. Oxygen is supplied via a main line positioned between the two columns and comprising a branch-off for each column. The hydrogen supply for each column is, for its part, by way of a single line supplying the stacks of each of the columns in series.

U.S. Pat. No. 6,110,612 for its part describes a support structure for mounting four fuel cell modules and the supply and discharge of the various fluids needed for the operation of all the modules.

However, difficulties are encountered when operating a collection of several identical fuel cell modules arranged as described in the aforesaid documents: the modules situated toward the downstream end of the supply, whether this be the oxygen supply, the hydrogen supply, or even the cooling-fluid supply, are not supplied in a way that is perfectly identical to the way in which the modules situated toward the upstream side of the supply are supplied. This means that different powers occur according to the position of the various modules in the collection that forms the fuel cell.

Because of such risks of undersupplying a module situated toward the downstream side of the supply, operating safety cannot be ensured. Such undersupply could actually cause the individual cells of the module in question to dip to a negative voltage and this could, after a certain length of time, lead to internal heating of the module and a risk of the module catching fire or even exploding.

An object of the present invention is to eliminate these difficulties and make it possible to achieve perfectly uniform distribution of the fluids in a collection of identical fuel cell modules, particularly where such a collection is mounted in a motor vehicle.

Another object of the present invention is to improve the operating safety of a collection of several identical fuel cell modules.

In one embodiment, the line set provides for the supply and/or discharge of fluids for a collection of at least two identical fuel cell modules, particularly a collection mounted in a motor vehicle. Each module comprises a stack of elemental individual cells and inlet and outlet ducts for various fluids needed for the operation of the fuel cell. The inlet and outlet ducts are arranged on at least one external face of each module. The supply and/or discharge lines for at least one of said fluids are connected to the corresponding ducts of all the modules by a single main line and one or more successive secondary branches the structures of which are symmetric for each respective module.

The symmetric structure of the secondary branches means that identical flow rates can be ensured for all the modules.

For preference, the lengths, the cross sections or the internal diameters and the radii of curvature of the successive secondary branches are, in each instance, equal for each respective module.

Thus, the velocity and the pressure drops are, in each instance, equal and all the modules are indeed supplied identically and/or discharged identically regardless of the flow rate involved. The distribution of fluids through all the identical modules of the collection of modules can be perfectly uniform, guaranteeing optimal overall performance. The operating safety of the collection is also improved as a result of this, because there is no longer any risk of one specific module being undersupplied.

The electrical power delivered by each module can be identical, thus simplifying operation control.

In one embodiment, the ducts connected to the various secondary branches are arranged on corresponding facing faces of the collection of modules.

In another embodiment, the ducts connected to the various secondary branches are arranged on corresponding opposing faces of the collection of modules.

For preference, at least the supply lines for supplying the fluids to the cathode and anode compartments of the modules are connected to the corresponding ducts of all of the modules by a single main line and one or more successive secondary branches the structures of which are symmetric for each respective module.

In an advantageous embodiment the supply and/or discharge lines that supply and/or discharge the heat-transfer fluid for maintaining the operating temperature of the modules are connected to the corresponding ducts of all the modules by a single main line and one or more successive secondary branches the structures of which are symmetric for each respective module.

The identical modules may be arranged in various ways to form the aforementioned collection of modules. In a preferred embodiment that is particularly suited to installation under the floor of a motor vehicle, the identical modules are positioned in a substantially horizontal plane. Those faces of the modules that bear the ducts thus advantageously lie in substantially vertical planes, each single main line and its associated successive secondary branches being arranged substantially in a horizontal plane.

The invention will be better understood from studying several particular embodiments taken by way of entirely nonlimiting examples and illustrated by the attached drawings in which:

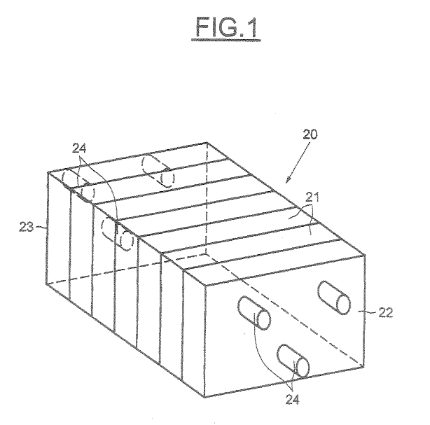

FIG. 1 is a perspective view of a fuel cell module comprising a stack of several elemental individual cells;

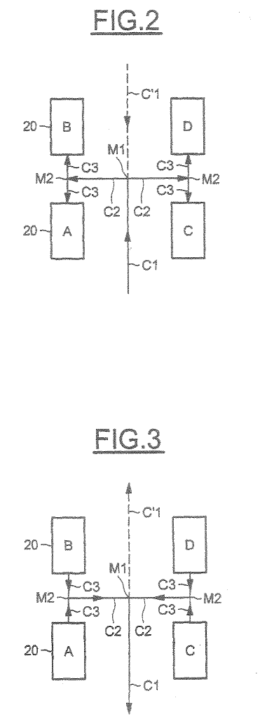

FIGS. 2 to 5 schematically illustrate various arrangements of supply and/or discharge lines for a particular fluid in the case of a collection of four identical fuel cell modules, and do so in various configurations;

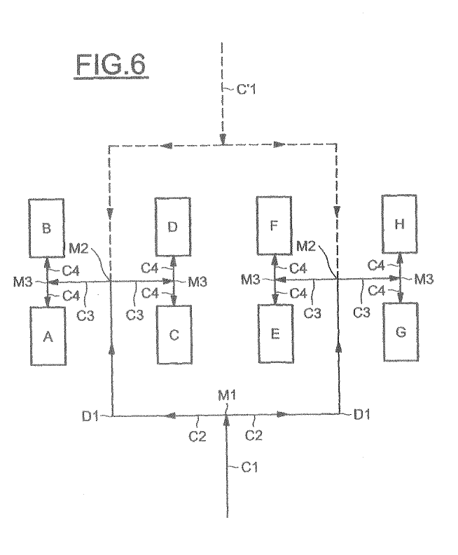

FIG. 6 is a schematic view similar to FIGS. 2 to 5 in the case of a configuration comprising eight identical fuel cell modules in one example of a layout;

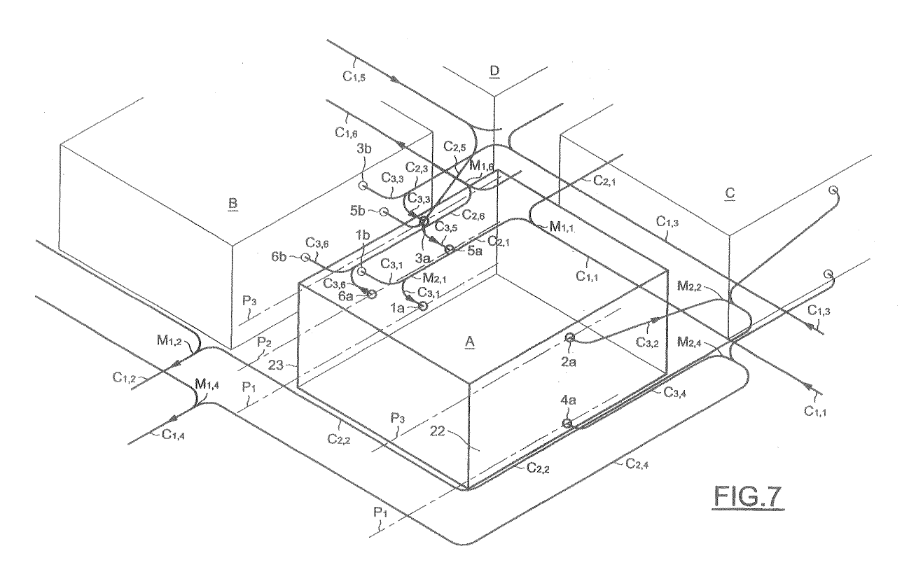

FIG. 7 is a perspective view schematically showing the outlines of the arrangement of the various supply and/or discharge lines of one particular module forming part of a collection of four fuel cell modules;

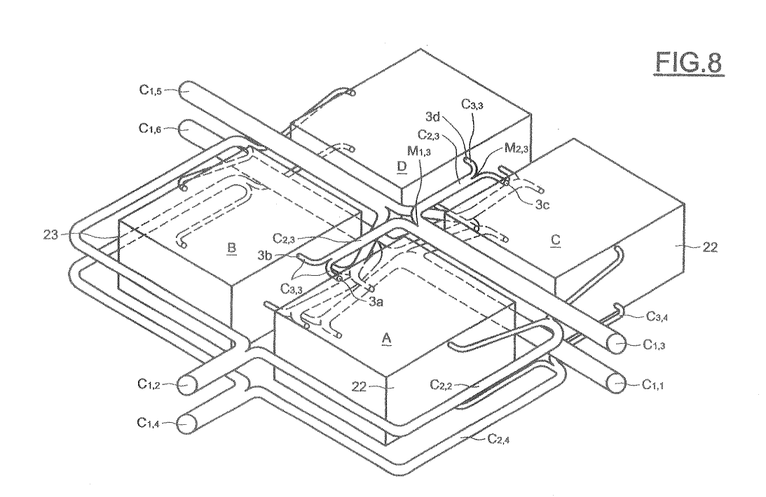

FIG. 8 is a perspective view showing one practical embodiment of an arrangement of supply and/or discharge lines for supplying and/or discharging all the fluids needed for the operation of a collection of four identical fuel cell modules for a motor vehicle; and

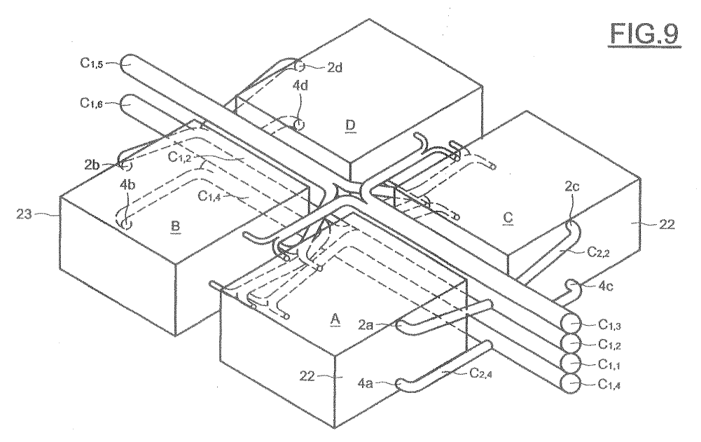

FIG. 9 is a view similar to FIG. 8 showing another arrangement in which the layout of symmetric lines is provided only for some of the fluids needed for the operation of the collection of four identical fuel cell modules.

As illustrated in FIG. 1, the fuel cell module referenced 20 in its entirety comprises a stack of a plurality of elemental individual cells 21 (in practice, around one hundred or so: just some have been depicted in the figure). The stack that makes up the module 20 has a front face 22 and an opposite or rear face 23. Various inlet and outlet ducts, referenced 24, may be arranged on the faces 22 and 23. In the example illustrated in the figure, each of the faces 22, 23 has three inlet and/or outlet ducts 24. It will of course be understood that the number of inlet and/or outlet ducts on each face 22, 23 depends on the internal architecture of the module 20. The same is true of the arrangement of the ducts 24 on the faces 22 and 23.

In order for a fuel cell module such as the module 20 illustrated in FIG. 1 to work, it is necessary to circulate a hydrogen-rich gas to the anode compartment, to circulate an oxygen-rich gas, such as air, to the cathode compartment and, in order to keep the operating temperature at a suitable level, to circulate a heat-transfer fluid to cool the module. It is therefore necessary to provide six ducts 24 namely:
one for letting hydrogen into the anode,
one for letting unused hydrogen out from the anode,
one for letting air into the cathode,
one for letting unused air out from the cathode,
one for letting the cooling fluid in, and
one for letting the cooling fluid out.

The outlet ducts are for recovering the excess anode and cathode fluids which have not reacted in the module.

As indicated before, it is necessary to combine several identical modules, such as the module 20, in the form of a collection in order to obtain the necessary power, for example for motor vehicle traction.

FIGS. 2 to 5 illustrate examples of layouts of supply and/or discharge lines for one of the fluids, in the case of a collection of four modules identical to the module 20 of FIG. 1.

In FIG. 2, the four modules A, B, C and D are arranged substantially in a horizontal plane at the four corners of a square. The fluid considered by way of example may be hydrogen or oxygen or alternatively may be the cooling fluid. In the example illustrated in FIG. 2, a main line C₁ brings the fluid from the front of the motor vehicle considered as being the bottom part of FIG. 2, rearward, as far as a point M₁ situated substantially at the center of symmetry of the four modules A, B, C and D. At the point M₁, the main line C₁, splits into two secondary branches C₂, one leading toward the modules A and B and the other toward the modules C and D, this being substantially mid-way between them. The two secondary branches C₂ run from the branch-off point M₁ as far as a second branch-off point M₂, where they split once again into two secondary branches C₃. Each of these branches C₃ is connected to an inlet duct of one of the modules A, B, C and D. In this example, the modules A and C are arranged in the same way with their rear face comprising the inlet duct for the fluid in question. The two modules B and D have been rotated through 180° with respect to the two modules A and C. Their inlet duct for the same fluid therefore faces forward. The inlet ducts of the various modules, for the fluid in question, therefore face each other.

Since the fluid is brought from the front via the main nine C₁ it will be understood that it is then distributed perfectly symmetrically to the four modules A B, C and D. This is because the respective lengths of the two secondary branches C₂ and the four secondary branches C₃ are identical to one another. The path followed by the fluid in order to supply each of the four modules is therefore of the same length.

In order to ensure perfect uniformity of the distribution of the fluid, provision is further made for the internal diameter of the secondary branches C₂ to be half the internal diameter of the main line C₁. Likewise, the internal diameter of the secondary branches C₃ is half the internal diameter of the secondary branches C₂ or, and this amounts to the same, one quarter of the internal diameter of the main line C₁. Thanks to this arrangement it may be seen that the pressure drops in the flow of the fluid are exactly the same for each of the four identical modules. If the lines are not of circular cross section, the same measures will be adopted through the ratios of the cross sections of the various lines and secondary branches.

It is preferable also to take the precaution of ensuring identical radii of curvature at the meeting points M₁ and M₂ in order, here again, to ensure identical flow velocities and identical pressure drops in the supply to each of the four modules A, B, C and D.

FIG. 2 also illustrates, in dotted line, a variant in which the main line C′₁ originates not from the front of the motor vehicle, but now from the rear. As in the preceding variant, the main line C′₁ ends at the branching point M₁ and subdivides into secondary branches C₂ and C₃ for supplying the four identical modules.

Of course, to simplify the drawing, the latter shows only the supply of one of the fluids, such as the hydrogen, the oxygen or a cooling fluid. It will be understood that the supply of the other fluids and/or the removal of all the fluids may be designed in the same way.

FIG. 3 illustrates one layout of the four identical modules A, B, C and D which is identical to that of FIG. 2. In this case, however the discharge for a fluid via a line also referenced C₁ and originating from a central point M₁ has been depicted, at the location of a branching with two secondary branches C₂. Two other branching points M₂ lie at the point where the secondary branches C₃ originating from the outlet ducts of each of the four modules A, B, C and D meet in the secondary branch C₂.

FIG. 3 also depicts a variant in which the discharge line C′₁ leads toward the rear of the vehicle.

FIG. 4 illustrates the case where the inlet ducts of the various modules A, B, C and D for the fluid in question no longer lie facing each other but, by contrast, lie on the opposing faces of the various modules. In this case, the main line C₁ which originates from one of the sides of the vehicle, leads to the branching point M₁ where it splits into two secondary branches C₂ which end at two branching points M₂ situated one on the front side and one on the rear side of the collection of four modules A, B, C and D along the axis of symmetry of the collection. From the branching points M₂, the secondary branches C₃ are connected to the inlet ducts of the four respective modules. It will be noted that the secondary branches have two elbows referenced D₁ and D₂, while each of the secondary branches C₃ has one elbow referenced D₃.

As before, in the examples illustrated in FIGS. 2 and 3, the cross section or the diameter of the secondary branches C₂ is half the cross section or the internal diameter of the main line C₁, whereas the cross section or the internal diameter of the secondary branches C₃ is equal to half the cross section or the internal diameter of the secondary branches C₂. The layout of the lines C₁, C₂, C₃ is perfectly symmetric with respect to the main line C₁, as was the case in the embodiments of FIGS. 2 and 3. The fluid supply along these supply lines as illustrated in FIG. 4 is therefore perfectly uniform. Here again, as in the preceding embodiment, the radii of curvature of the various secondary branches are, in each instance, identical, so as to maintain the symmetry and therefore the uniformity of the distribution of the fluid.

FIG. 4, again in dotted line, depicts a layout in which the main line C₁ instead of coming from the left of FIG. 4 comes from the right of FIG. 4.

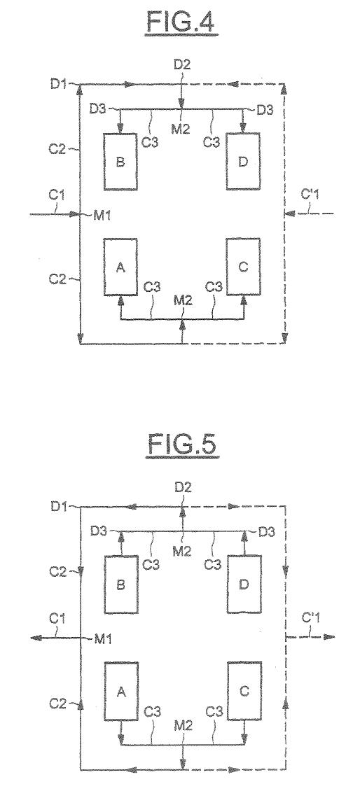

FIG. 5 illustrates a layout identical to that of FIG. 4, in which the line depicted is a discharge line, the outlet ducts for the fluid in question being situated on the opposed external faces of the various modules A, B, C and D.

FIG. 6 illustrates a collection comprising eight identical fuel cell modules. Four modules A, B, C and D configured as they were in the embodiments of the preceding figures are arranged in the same horizontal plane and beside four identical modules E, F, G and H configured in the same way as the modules A, B, C and D. In this example, which corresponds substantially to that of FIG. 2, a feedline arrangement has been shown where the inlet ducts for the corresponding fluid are to be found on the facing faces of the various modules. The main line C₁, carries the fluid in question from the front of the vehicle as far as the point M₁ where it divides into two secondary branches C₂ which, after an elbow D₁, arrives at a second branching point M₂ situated substantially at the respective centers of the two groups of four modules: A, B, C, D on the one hand, and E, F, G, H on the other. From there on, the layout is analogous to that of FIG. 2, with two secondary branches C₃ as far as the branching point M₃ from which two secondary branches C₄ continue, each of these being connected to an inlet duct of one of the eight modules A to H.

As was the case earlier, the supply line layout for the fluid in question is perfectly symmetric with respect to the main line C₁, the lengths of each of the secondary branches in each instance being equal as far as the next branching point.

The same rule of reduction in cross section or of internal diameter of the lines is also applied, the secondary branch C₂ having a cross section or a diameter half that of the main line C₁, the secondary branch C₃ being of a cross section or of an internal diameter half that of the secondary branch C₂ and the secondary branch C₄ being of a diameter half that of the secondary branch C₃. The radii of curvature are also preferably kept identical in each bend.

In this way, as in the preceding embodiments, a perfectly uniform distribution of fluid is obtained over the eight identical fuel cell modules.

FIG. 6 shows, in dotted line, a supply C′₁ from the rear of the vehicle.

FIG. 7 more precisely illustrates one layout of all the supply and discharge lines for a fuel cell module such as the module A of a collection of four identical modules arranged substantially in a horizontal plane at the four corners of a square.

FIG. 7 depicts only the centerline of the various supply and discharge lines for the module A. It will of course be understood that similar lines are provided for the other identical modules B, C and D.

In the example illustrated the module A comprises, on its front face 22 an outlet duct 2a for hydrogen not used in the anode part and an outlet duct 4a for the air not used in the cathode.

The rear face 23 of the module A has four ducts, namely a duct 1a for letting hydrogen into the anode compartment, a duct 3a for letting air into the cathode compartment, a duct 5a for letting in cooling fluid and a duct 6a for letting the cooling fluid out.

In the example illustrated the ducts 2a and 3a situated on the faces 22 and 23 respectively are both situated in an upper horizontal plane denoted P₃. The two ducts 5a, 6a located on the face 23 are situated in an intermediate horizontal plane denoted P₂. Finally, the two ducts 1a and 4a situated on the faces 23 and 22 respectively are situated in a lower horizontal plane denoted P₁.

If we consider first of all the duct 1a for letting the hydrogen into the anode part, the hydrogen is supplied via a main line C_{1,1} as far as the branching point M_{1,1} from where a secondary branch C_{2,1} leads as far as a branching point M_{2,1} from where a secondary branch C_{3,1} in particular extends. It is thus evident that the inlet duct 1a of the module A is supplied with hydrogen via the successive lines C_{1,1}, C_{2,1} and C_{3,1} the cross sections or diameters of which are, in each instance, halved as explained before. The figure also shows, depicted in fine line, the ducts 1b, 3b, 5b and 6b of the module B which face the corresponding ducts of the module A. The duct 1b is supplied via a secondary branch C_{3,1} extending toward the module B from the branching point M_{2,1}. Likewise, the modules C and D may be supplied via a secondary branch C_{2,1} which begins at the branching point M_{1,1}.

If we now consider the outlet duct 2a of the module A it can be seen that this duct is connected to the main line C_{1,2} which comes from the left of all the modules, which splits into two secondary branches C_{2,2}, one of which runs around two sides of the module A to arrive at the branching point M_{2,2} from which a secondary branch C_{3,2} is connected to the outlet duct 2a.

The layout of the discharge line connected to the outlet duct 4a is substantially identical to that of the lines connected to the outlet duct 2a.

Specifically, the outlet duct 4a is connected to the main line C_{1,4} via the secondary branch C_{2,4} and the secondary branch C_{3,4}.

The supply lines supplying the inlet duct 3a are configured substantially in the same way as the supply lines supplying the inlet duct 1a. Specifically, the inlet duct 3a is connected to the main line C_{1,3}, to a secondary line C_{2,3}, itself connected to a secondary branch C_{3,3}.

The discharge line connected to the outlet duct 6a comprises a main line C_{1,6} which, after the junction point M_{1,6}, slits into two secondary branches C_{2,6} then into two secondary branches C_{3,6}.

The supply line connected to the inlet duct 5a also comprises a main line C_{1,5} which splits into two secondary branches C_{2,5}, then into two secondary branches C_{3,5}.

It will be noted that the main lines C_{1,1} and C_{1,3} respectively supplying the inlet ducts 1a and 3a lie on the front side of the vehicle, that is to say on the same side as the front face 22 of the module A. These two ducts are positioned between the two modules A and C. In general, they lie one above the other in a vertical plane, level with the planes P₃ and P₁ respectively, the main line C_{1,3} lying above the main line C_{1,1}.

The two discharge lines C_{1,2} and C_{1,4} connected respectively to the outlet ducts 2a and 4a are, for their part, situated on the left-hand side relative to the figure. They lie substantially in a vertical plane, the line C_{1,2} being above the line C_{1,4} level with the planes P₃ and P₁ respectively, that is to say level with the same planes as the outlet ducts 2a and 4a. They also lie substantially on an axis between the modules A and B.

Finally, the main ducts C_{1,5} and C_{1,6} are both situated on the rear side, that is to say on the same side as the rear face 23 of the module A. They lie substantially in a vertical plane.

It will be noted that the supply line supplying cooling fluid C_{1,5} runs from the upper first plane P₃ to the intermediate plane P₂ in which the inlet duct 5a lies.

To do this, the secondary branch C_{2,5} is inclined to run from the plane P₃ to the plane P₂.

FIG. 8 illustrates one practical embodiment which repeats the principles of FIG. 7, the configuration being the same as in FIG. 7.

FIG. 8 fully depicts the four identical fuel cell modules A, B, C and D and the full layout of the fluid supply and discharge lines in the same general arrangement as in FIG. 7. The six main lines are grouped in pairs, as was the case in FIG. 7. The main lines C_{1,1} for supplying the anode compartments with hydrogen and C_{1,3} for supplying the cathode compartments with air are configured at the rear of the vehicle on the same side as the faces 22 of the two modules A and C. These two main lines C_{1,1} and C_{1,3} are placed one above the other substantially in a vertical plane in the space between the two modules A and C.

The two main lines C_{1,5} for supplying cooing fluid and C_{1,6} for returning the cooling fluid emerge from the opposed side, that is to say on the front side of the vehicle or the same side as the faces 23 of the two modules B and D. These two main lines are positioned substantially in a vertical plane and lie in the space between the two modules B and D.

Finally, the two main lines C_{1,2} for discharging the hydrogen from the anode compartments and C_{1,4} for letting out air from the cathode compartments are configured on the side of the two modules A and B.

The collection of lines and associated secondary branches is designed symmetrically according to the invention. Thus, for example, FIG. 8 shows the configuration of the two secondary branches C_{2,3} which leave the branching point M_{1,3} and are connected to the main line C_{1,3} for supplying the cathode compartments of the four modules A, B, C and D with air. FIG. 8 shows that the diameter of the secondary branches C_{2,3} is half the internal diameter of the main line C_{1,3}. At the branching points M_{2,3}, the secondary branches C_{2,3} split again into two secondary branches C_{3,3} the internal diameter of which is half the internal diameter of the secondary branches C_{2,3}.

It will be understood that in this way the supply of air to the cathode compartments of the four identical modules A, B, C and D is over the four corresponding inlet ducts 3a, 3b, 3c and 3d in a way that is perfectly uniform and identical, given that the length of the lines is exactly the same for all four modules A, B, C and D. Likewise, given the symmetric reduction in the internal diameters of the various secondary branches, the pressure drops and the flow velocities of the supply air are the same for the four modules A, B, C and D. In addition, the radii of curvature of each elbow are identical in each instance.

The same results are obtained through the same means in respect of the supply and discharge of the other fluids.

FIG. 9 illustrates a variant in which just part of the fluids enjoys perfectly uniform distribution according to the invention. Apart from this difference, the structure of the layout of the feed and discharge lines is the same and we once again find the four identical modules A, B, C and D of FIG. 8, configured in the same way.

The structure and layout of the main lines and of the secondary branches for supplying and discharging the cooling fluid are the same as in FIG. 8. Thus, we again have the layout of the two main lines C_{1,5} for supplying the cooling fluid and C_{1,6} for discharging the cooling fluid on the front side of the vehicle, that is to say on the same side as the front faces 23 of the two modules B and D. Likewise, we again find the structure and layout of the main lines C_{1,3} for supplying the cathode compartments with air and C_{1,1} for supplying the anode compartments with hydrogen. These main lines are arranged on the rear side of the vehicle on the same side as the rear faces 22 of the two modules A and C, as they were in FIG. 8.

However, unlike in FIG. 8, the main lines C_{1,2} for discharging the hydrogen not used by the anode compartments and C_{1,4} for letting air out of the cathode compartments are also arranged on the rear side of the vehicle so that all the main lines C_{1,3}, C_{1,2}, C_{1,1} and C_{1,4} are arranged in a vertical plane on the rear side of the vehicle, in the space left between the two identical modules A and C. The layout of the main lines C_{1,2} and C_{1,4} and of their secondary branches is therefore not entirely symmetric for the four modules A, B, C and D, to the detriment of the uniformity of the flow. This configuration does, however, have the advantage of better integration into the vehicle, given that the various main lines are arranged on the rear side of the vehicle. The main line C_{1,4} and the main line C_{1,2} run in a straight line in the space between the modules A and C, then in the space between the modules B and D. The secondary branches, such as C_{2,4} or C_{2,2}, the diameter of which is equal to half the internal diameter of the corresponding main lines C_{1,4} and C_{1,2} allow for the flow of air and hydrogen from the four modules from the respective outlet ducts 2a, 2b, 2c, 2d and 4a, 4b, 4c, 4d of the four modules A, B, C and D. Bearing in mind the configuration of the modules, these outlet ducts are located on the rear faces 22 on the rear side of the vehicle in the case of modules A and C, and on the front faces 23 on the front side of the vehicle in the case of modules B and D.

1-7. (canceled)

8. A fluid supply and/or discharge line set for a collection of at least two identical fuel cell modules, or a collection of fuel cells mounted in a motor vehicle, each comprising:
a stack of elemental individual cells and inlet and outlet ducts for different fluids needed for operation of the fuel cell, the ducts being arranged on at least one external face of each module,
wherein supply and/or discharge lines for at least one of the fluids are connected to corresponding ducts of all the modules by a single main line and one or more successive secondary branches that are symmetric for each respective module.

9. The line set as claimed in claim 8, wherein lengths, cross sections, or internal diameters and the radii of curvature of the successive secondary branches are, in each instance, equal for each respective module.

10. The line set as claimed in claim 8, wherein the ducts connected to the successive secondary branches are arranged on corresponding facing faces of the collection of modules.

11. The line set as claimed in claim 8, wherein the ducts connected to the successive secondary branches are arranged on corresponding opposing faces of the collection of modules.

12. The line set as claimed in claim 8, wherein at least the supply lines for supplying the fluids to cathode and anode compartments of the modules are connected to the corresponding ducts of all of the modules by a single main line and one or more successive secondary branches the structures that are symmetric for each respective module.

13. The line set as claimed in claim 12, wherein the supply and/or discharge lines supply and/or discharge a heat-transfer fluid for maintaining an operating temperature of the modules, and are connected to the corresponding ducts of all the modules by a single main line and one or more successive secondary branches that are symmetric for each respective module.

14. The line set as claimed in claim 8, wherein the modules are identical and are positioned in a substantially horizontal plane, those faces of the modules that bear the ducts lying in substantially vertical planes, each single main line and its associated successive secondary branches being arranged substantially in a horizontal plane.
